(19) United States
(12) Patent Application Publication
(10) Pub. No.: US 2022/0185611 A1
(43) Pub. Date: Jun. 16, 2022

(54) TAPE DISPENSER

(71) Applicant: 3M INNOVATIVE PROPERTIES COMPANY, St. Paul, MN (US)

(72) Inventors: Moonkyoung Jang, Hwaseong-si (KR); In-Hwan Lee, Hwaseong-si (KR)

(21) Appl. No.: 17/436,682

(22) PCT Filed: Mar. 6, 2020
(86) PCT No.: PCT/IB2020/051989

§ 371 Date: Sep. 7, 2021

(30) Foreign Application Priority Data
Mar. 15, 2019 (KR) 10-2019-0029946

(51) Int. Cl. B65H 35/00

(52) U.S. Cl. CPC B65H 35/0026; B65H 35/0086; B65H 2701/377; B65H 2301/51532; B65H 2301/5154; B65H 2301/51512

(57) ABSTRACT

A tape dispenser according to an embodiment of the present disclosure includes: a lower case configured to accommodate a tape therein, and including a tape support to which a portion of the tape is adhered; an upper case connected to the lower case; a blade portion coupled to the upper case to cut the tape; and a protection cap assembly provided on a bottom surface of the upper case to cover the blade portion, wherein, when the protection cap assembly is pressed by the support, the protection cap assembly is inserted toward the bottom surface of the upper case to expose at least a portion of the blade portion to an outside.

### BACKGROUND

### Technical Field

The present disclosure relates to a tape dispenser.

### Background Art

In general, a taping process is performed by using a roll type tape to finish packing of various products or packing with packing paper, a packing box, etc. The roll type tape is mounted and used in a separate tape dispenser to be cut for use.

A tape is rotatably coupled to the tape dispenser, and the wound tape is cut by a cutting device provided in the tape dispenser while being unwound by rotation.

However, in the case of a related-art tape dispenser, a cutting portion provided to cut the tape, such as a cutter, a blade, or the like, is exposed to the outside. Accordingly, there is a problem that a safety accident frequently occurs when a user uncarefully uses the tape dispenser.

### SUMMARY

### Technical Problem

The present disclosure includes solutions developed to solve the above-described problems, and an object of the present disclosure is to provide a tape dispenser which can easily cut a tape, and can prevent a safety accident caused by a blade portion.

### Technical Solution

A tape dispenser according to an embodiment of the present disclosure may include: a lower case configured to accommodate a tape therein, and including a tape support to which a portion of the tape is adhered; an upper case connected to the lower case; a blade portion coupled to the upper case to cut the tape; and a protection cap assembly provided on a bottom surface of the upper case to cover the blade portion, wherein, when the protection cap assembly is pressed by the support, the protection cap assembly is inserted toward the bottom surface of the upper case to expose at least a portion of the blade portion to an outside.

In the tape dispenser according to an embodiment of the present disclosure, the protection cap assembly may include: a cover plate configured to cover the blade portion and provided to be inserted into the bottom surface of the upper case; a locking member disposed between the cover plate and the bottom surface of the upper case to selectively restrict a movement of the cover plate; and a first elastic member having one side connected to the cover plate and the other side connected to the upper case, and configured to apply an elastic force to the cover plate in an outward direction.

### Advantageous Effects

The tape dispenser according to an embodiment of the present disclosure can easily cut the tape, particularly tape on a backing including foam, and can prevent a safety accident caused by the blade portion.

### BRIEF DESCRIPTION OF THE DRAWINGS

FIG. 1 is a perspective view of a tape dispenser according to an embodiment of the present disclosure;

FIG. 2 is a perspective view illustrating a state in which a tape is coupled to the tape dispenser according to an embodiment of the present disclosure;

FIG. 3 is an exploded perspective view of the tape dispenser according to an embodiment of the present disclosure;

FIG. 4 is a bottom perspective view of the tape dispenser according to an embodiment of the present disclosure;

FIG. 5 is an exploded perspective view of an upper case and a protection cap assembly in the tape dispenser according to an embodiment of the present disclosure;

FIG. 6 is a side view illustrating a blade exposed to the outside of the protection cap assembly in the tape dispenser according to an embodiment of the present disclosure;

FIG. 7 is an exploded perspective view of the upper case and the protection cap assembly in the tape dispenser according to another embodiment of the present disclosure;

FIG. 8 is a cross-sectional view illustrating a state before a support and the protection cap assembly come into contact with each other;

FIG. 9 is a cross-sectional view illustrating a state in which the support and the protection cap assembly come into contact with each other; and

FIGS. 10 to 13 are exploded perspective views illustrating various variations of the blade portion of FIG. 7.

### DETAILED DESCRIPTION

Prior to describing the present disclosure in detail, it is noted that terms or words used in the detailed description and the claims described hereinbelow should not be interpreted as unduly limiting and the embodiments described in the detailed description and the configurations illustrated in the drawings are merely the most preferred embodiments, and do not represent all technical concepts of the present disclosure. Therefore, it should be understood that there may be various equivalents and variations substituting these at the time of filing of the present application.

Hereinafter, preferred embodiments of the present disclosure will be described in detail with reference to the accompanying drawings. It should be noted that the same elements are indicated by the same reference numerals in the accompanying drawings. In addition, well-known functions or constructions are not described in detail since they would obscure the main features of the present disclosure in unnecessary detail. For the same reason, some elements may be exaggerated, omitted or schematically illustrated in the drawings, and the size of each element does not entirely reflect a real size.

In addition, throughout the description, the expressions “upper side,” “lower side,” or the like are described with reference to illustrations in the drawings, and it is to be noted that these may be expressed differently when the orientation of a corresponding object is changed.

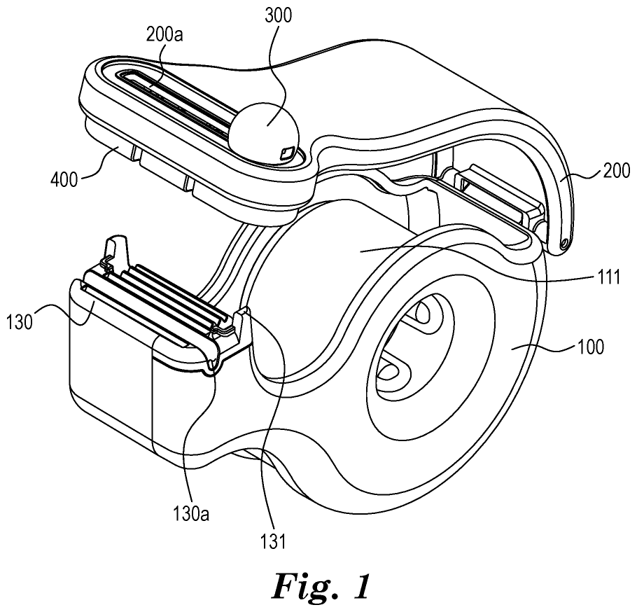

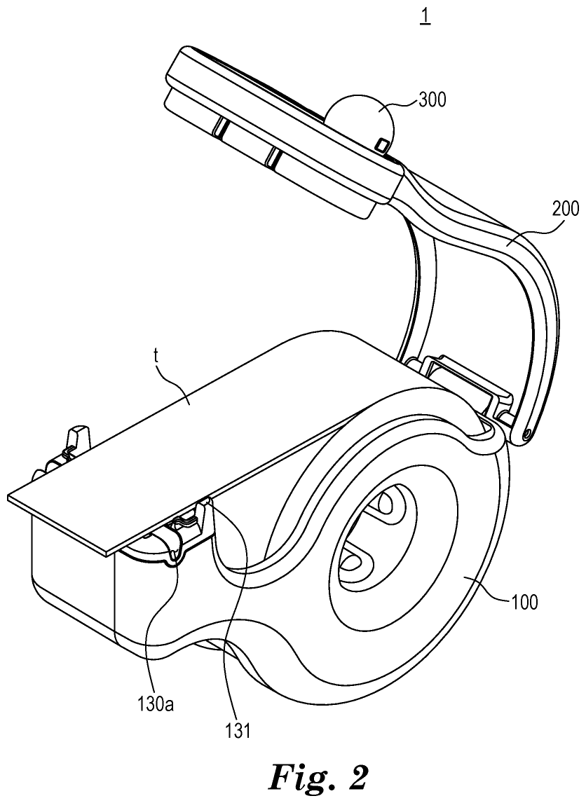

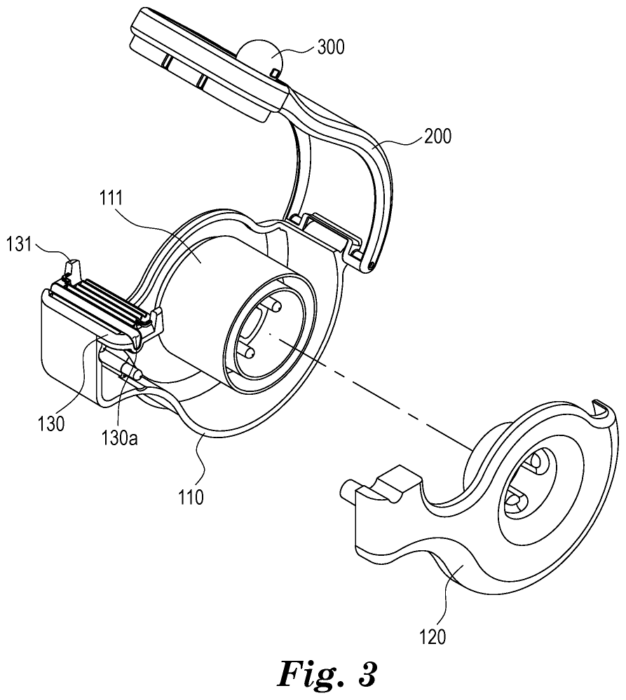

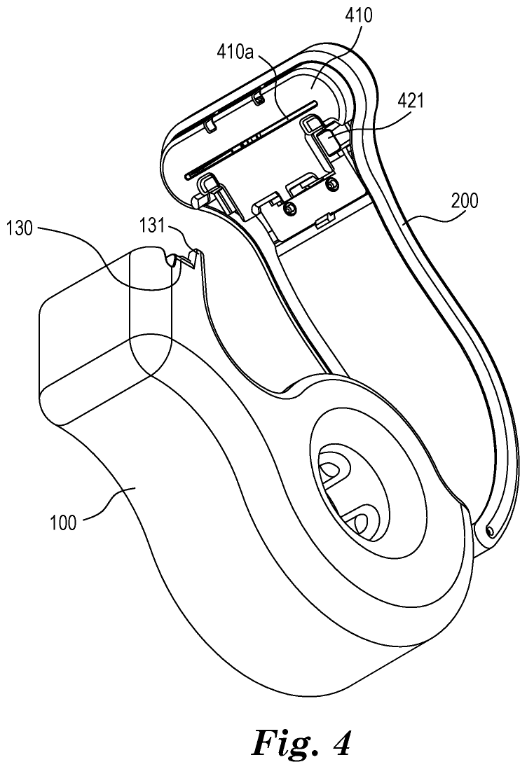

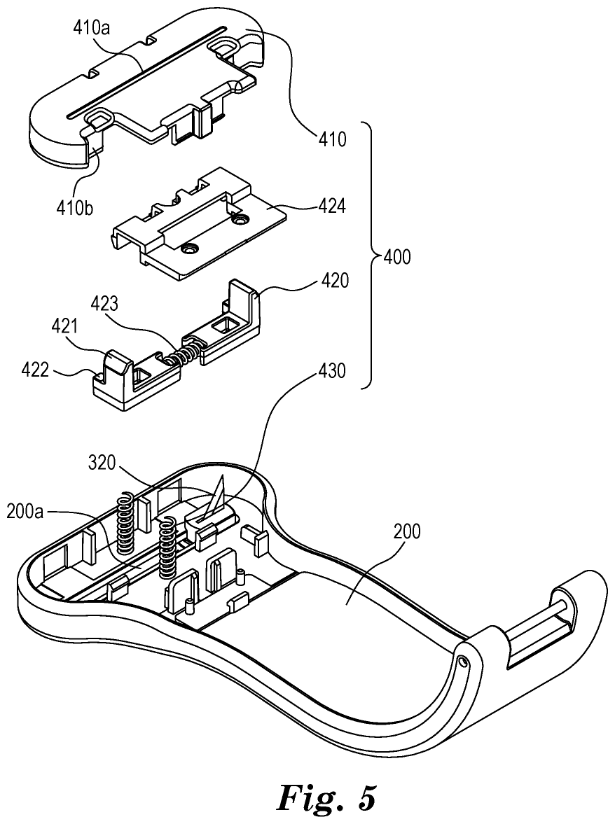

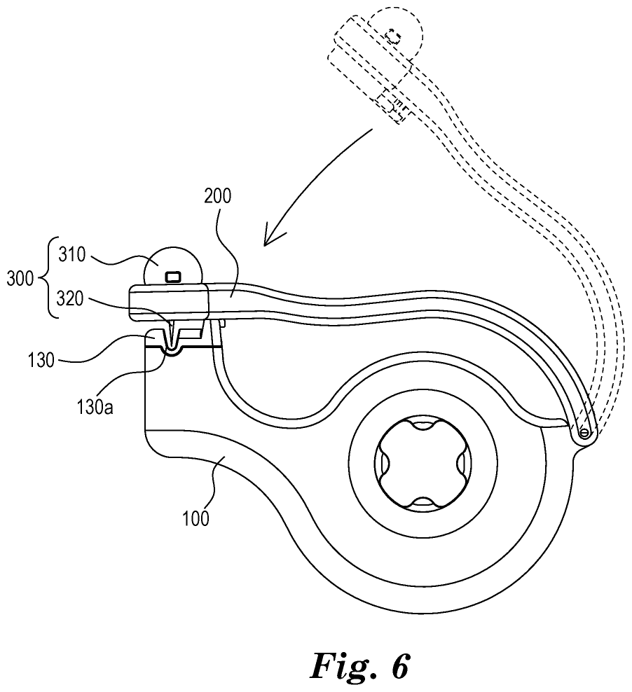

Referring to FIGS. 1 to 6, a tape dispenser 1 according to an embodiment of the present disclosure may include a lower case 100 in which a roll of tape (not shown) is accommodated, an upper case 200 connected to the lower case 100, a blade portion 300 coupled to the upper case 200 to cut the tape, and a protection cap assembly 400 provided on a bottom surface of the upper case 200 to cover the blade portion 300.

The tape roll may be rotatably coupled to the inside of the lower case 100. For example, the lower case 100 may include a first lower case 110 having a tape coupling portion 111 protruding therefrom, and a second lower case 120 coupled to one side of the first lower case 110 to define an inner space to accommodate the tape roll, and the tape roll may be rotatably coupled to the tape coupling portion 111.

The lower case 100 may be provided with a support 130. A portion of the tape may adhere to the support 130, and the blade portion 300 may cut the tape adhering to the support 130. The support 130 may have a guide groove 130a formed thereon. The guide groove 130a may be provided to prevent interference by the blade portion 300 and the support 130. A blade 320 of the blade portion 300 may slide with an end thereof being inserted into the guide groove 130a, and accordingly, the tape adhering to the support 130 may be cut. The guide groove 130a may be formed on the support 130 facing a second guide slit 410a of a cover plate 410 when the upper case 110 is rotated.

The support 130 may include a pressing protrusion 131 which comes into contact with a contact portion 421 and presses against the contact portion 421. The contact portion 421 may slide inwardly or outwardly by the pressing protrusion 131. When the contact portion 421 slides, the cover plate 410 may be inserted toward a bottom surface of the upper case 200, and as a result, the blade portion 300 may be exposed to the outside.

The upper case 200 may be connected to the lower case 100. For example, one side of the upper case 200 may be rotatably connected to the lower case 100, and the other side of the upper case 200 may be disposed to face the support 130 of the lower case 100 according to the rotation of the upper case 200.

The upper case 200 may be provided with the blade portion 300. The blade portion 300 may penetrate through the other side of the upper case 200 and may be slidably coupled thereto, and, to achieve this, a first guide slit 200a may be formed on the upper case 200 to guide a movement of the blade portion 300. The blade portion 300 may cut the tape while moving along the first guide slit 200a.

The blade portion 300 may include a blade handle 310 protruding from a top surface of the upper case 200, and a blade 320 connected to the blade handle 310 and exposed from the bottom surface of the upper case 200 by penetrating through the upper case 200. A user may cut the tape by sliding the blade handle 310. Herein, the blade 320 may be a blade that can cut in one direction or in both directions.

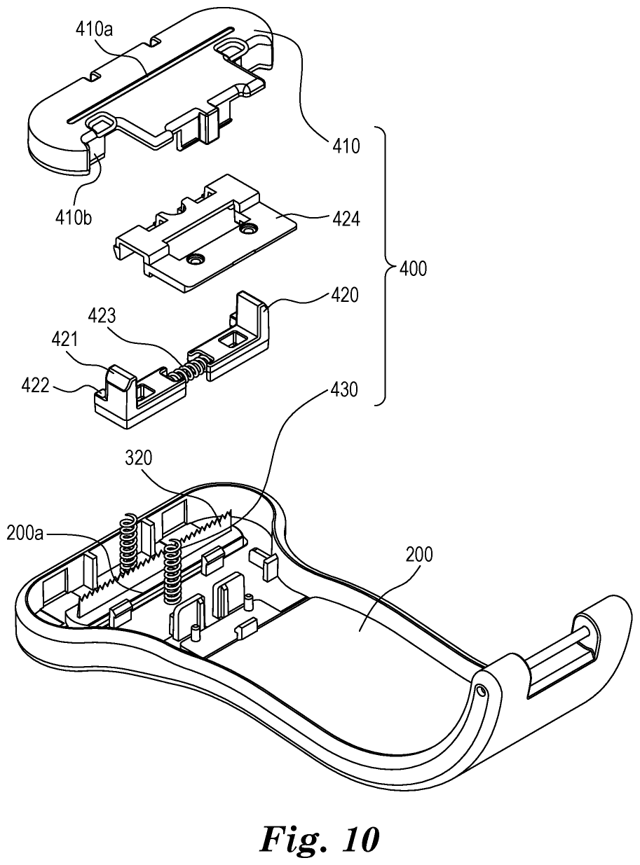

The blade portion 300 may be provided in various shapes as long as it is provided in the upper case 200 and can cut the tape. For example, referring to FIG. 10, the blade portion 300 may include a blade 320 in a saw blade shape having a plurality of cutting concavo-convex portions. When the blade 320 of the blade portion 300 is provided in the saw blade shape, the blade portion 300 may be fixedly coupled to the bottom surface of the upper case 200.

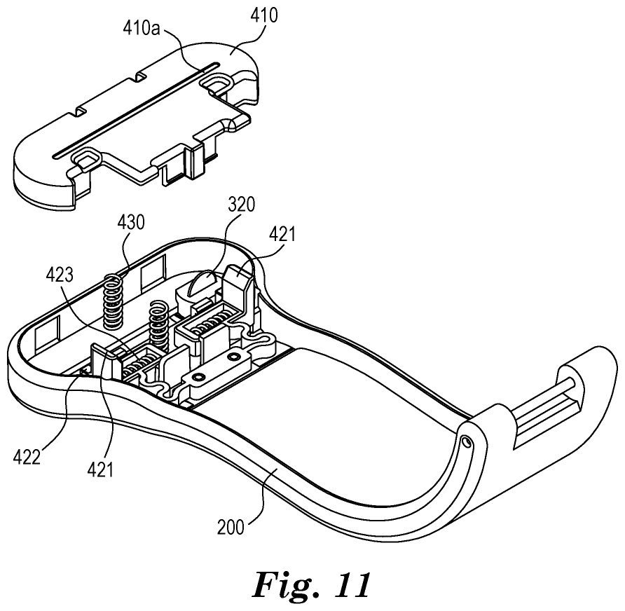

Alternatively, referring to FIG. 11, the blade portion 300 may include a blade 320 provided in a circular shape. The blade 320 may be fixed to the blade handle 310 and may be connected to the blade handle 310 by a hinge and may be rotatably provided. The blade 320 of the blade portion 300 is provided in the circular shape as described above, such that less force is required to cut the tape by using the blade portion 300 and a sense of smooth operation can be achieved.

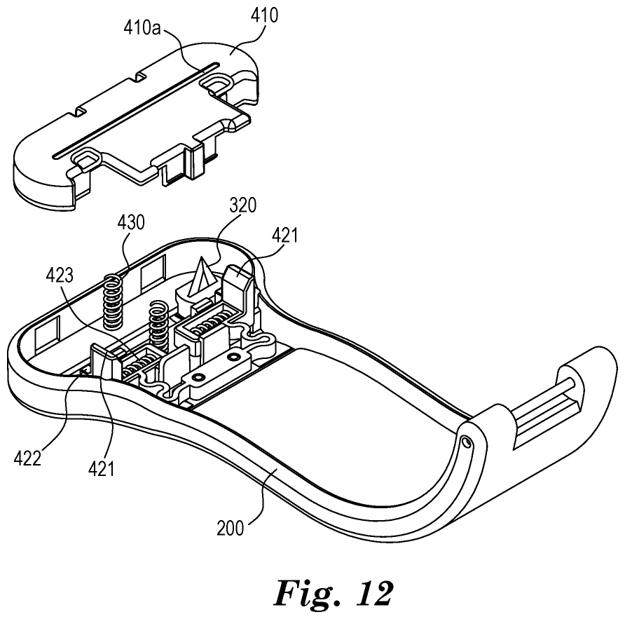

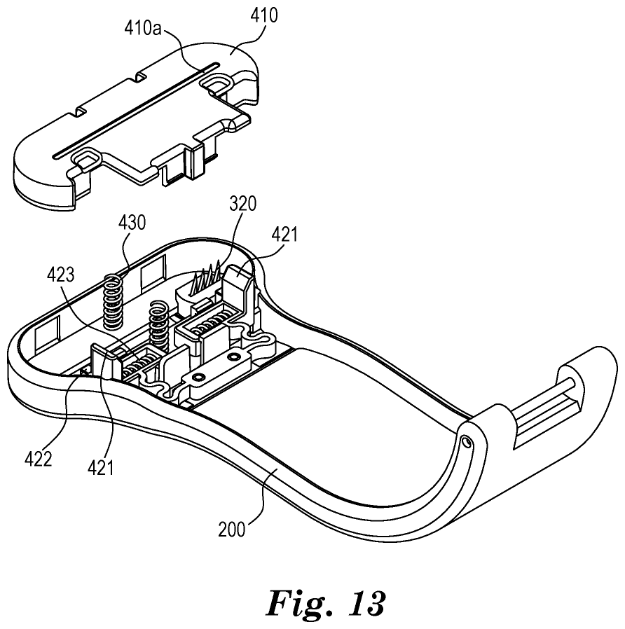

In addition, referring to FIG. 12, the blade 320 of the blade portion 300 may include a double-edged blade. Accordingly, since the blade portion 300 cuts while moving in both directions, there is an advantage that the tape may be cut more effectively. Furthermore, the blade 320 of the blade portion 300 may be provided in a saw blade shape as shown in FIG. 13 and may be provided to cut the tape while moving along with the blade handle 310. Accordingly, since there is an effect that a plurality of blades pass thought the tape only by a single movement, cutting can be more effective in certain circumstances than when a single blade is provided.

The protection cap assembly 400 may be provided on the bottom surface of the upper case 200. The protection cap assembly 400 may be provided to cover the blade 320 of the blade portion 300 exposed from the bottom surface of the upper case 200, and to selectively expose the blade 320 to the outside. In other words, when the protection cap assembly 400 is pressed by the support 130 of the lower case 100, the protection cap assembly 400 may be inserted toward the bottom surface of the upper case 200 and may expose at least a portion of the blade portion 300 to the outside. On the other hand, when the protection cap assembly 400 is not pressed by the support 130, the protection cap assembly 400 may not be inserted toward the bottom surface of the upper case 200, and accordingly, the blade 320 may not be exposed to the outside.

The protection cap assembly 400 may include the cover plate 410 provided to cover the blade portion 300 and to be inserted toward the bottom surface of the upper case 200, a locking member 420 disposed between the cover plate 410 and the bottom surface of the upper case 200 to selectively restrict a movement of the cover plate 410, and a first elastic member 430 to apply an elastic force to the cover plate 410 in an outward direction.

The cover plate 410 may be provided on the bottom surface of the upper case 200. For example, the cover plate 410 may be formed in a shape corresponding to a bottom surface of an end of the other side of the upper case 200. The cover plate 410 may be selectively inserted toward the bottom surface of the upper case 200. The cover plate 410 may have the second guide slit 410a formed thereon. The second guide slit 410a may be formed on a position facing the first guide slit 200a formed on the upper case 200. The blade 320 may be exposed to the outside through the second guide slit 410a when the cover plate 410 is inserted toward the bottom surface of the upper case 200.

The movement of the cover plate 410 may be selectively restricted by the locking member 420. For example, when the locking member 420 is spaced apart from the support 130, the movement of the cover plate 410 may be restricted, and, when the locking member 420 is pressed by the support 130 in contact with the support 130, the cover plate 410 may be inserted toward the bottom surface of the upper case 200.

The locking member 420 may include the contact portion 421 and a step portion 422. The contact portion 421 may be provided on the bottom surface of the upper case 200, and, when the contact portion 421 comes into contact with the pressing protrusion 131 of the support 130, the contact portion 421 may slide inwardly. The step portion 422 may be extended from one side of the contact portion 421. The step portion 422 may selectively restrict the movement of the cover plate 410. In other words, when the contact portion 421 does not come into contact with the support 130, the step portion 422 may be disposed on a movement path of one side 410b of the cover plate 410 to restrict the movement of the cover plate 410. On the other hand, when the contact portion 421 slides inwardly in contact with the support 130, the step portion 422 may deviate from the movement path of the cover plate 410, and accordingly, the cover plate 410 may be inserted toward the bottom surface of the upper case 200.

The locking member 420 may include a second elastic member 423 and a guide cover 424. The second elastic member 423 may be provided as a coil spring, for example, and applies an elastic force to the contact portion 421, such that the step portion 422 is disposed on the movement path of the cover plate 410. In other words, when the contact portion 421 is pressed in contact with the pressing protrusion 131, the contact portion 421 may slide inwardly, and in this case, the step portion 422 may deviate from the movement path of the cover plate 410. Thereafter, when the pressure is removed, the contact portion 421 may slide outwardly due to the second elastic member 423, and may be disposed on the movement path of the cover plate 410.

The guide cover 424 may be coupled to the bottom surface of the upper case 200 to guide the movement of the contact portion 421, and to prevent the contact portion 421 from being released from the upper case 200. The guide cover 424 may be provided in various shapes as long as it can guide the movement path of the contact portion 421.

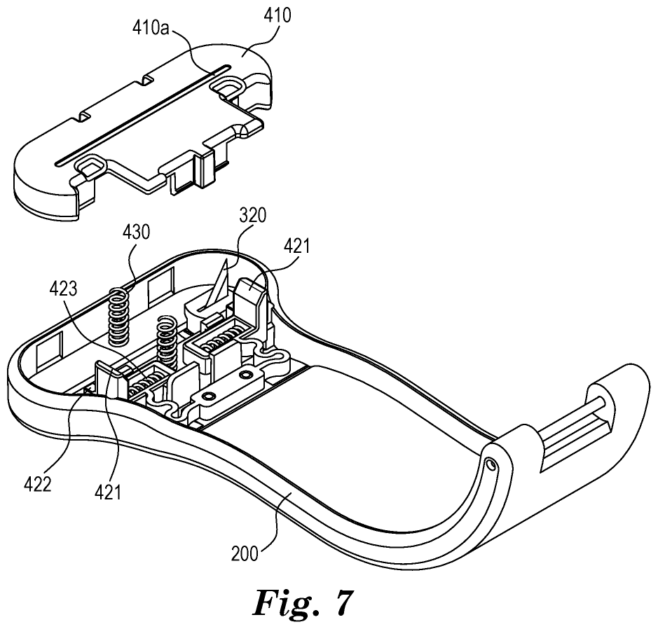

Referring to FIG. 7, the contact portion 421 may be provided to be slidable outwardly. In other words, FIGS. 1 to 6 disclose the configuration in which, when the contact portion 421 is pressed by the pressing protrusion 131, the contact portion 421 slides inwardly and removes interference by the cover plate 410 and the step portion 422. However, the contact portion 421 may slide outwardly to remove interference by the cover plate 410 and the step portion 422. In this case, the second elastic member 423 may apply an elastic force to the contact portion 421 in an inward direction.

The first elastic member 430 may have one side connected to the cover plate 410, and the other side connected to the upper case 200. Accordingly, the first elastic member 430 may apply an elastic force to the cover plate 410 in an outward direction.

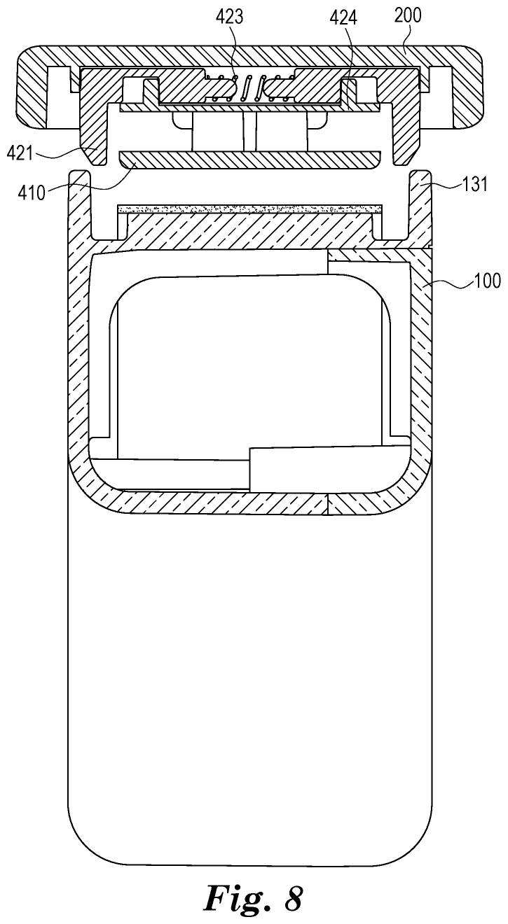

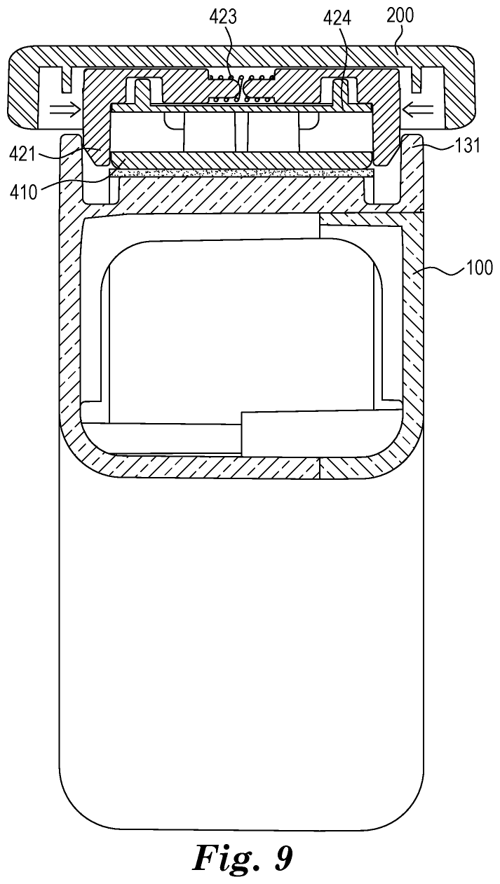

Hereinafter, an operation of the tape dispenser 1 according to an embodiment of the present disclosure will be described with reference to FIGS. 8 and 9.

Referring to FIG. 8, the protection cap assembly 400 of the tape dispenser 1 may be disposed to be spaced apart from the pressing protrusion 131. Therefore, the contact portion 421 and the pressing protrusion 131 are not in contact with each other, and the step portion 422 may be disposed on the movement path of one side 410b of the cover plate 410. Accordingly, the cover plate 410 may not be inserted into the bottom surface of the upper case 200 by the step portion 422. As a result, the protection cap assembly 400 can prevent the blade 320 from being exposed to the outside.

Referring to FIG. 9, when the upper case 200 rotates and the contact portion 421 is pressed by the pressing protrusion 131, the contact portion 421 and the step portion 422 may slide inwardly. Accordingly, the step portion 422 may deviate from the movement path of the cover plate 410. Thereafter, the cover plate 410 comes into contact with the support 130 and may be inserted into the bottom surface of the upper case 200. When the cover plate 410 is inserted, the blade 320 of the blade portion 300 may be exposed to the outside through the second guide slit 410a, and an exposed end may be inserted into the guide groove 130a formed on the support 130. In this case, when the user grips the blade handle 310 and slides the blade portion 300, the tape disposed between the support 130 and the cover plate 410 may be cut.

The tape dispenser 1 according to an embodiment of the present disclosure as described above exposes the blade 320 to the outside only when in use, such that a safety accident that may be caused by the blade 320 can be prevented.

While the configuration and features of the present disclosure have been described with reference to the embodiments of the present disclosure, the present disclosure is not limited thereto, and it is obvious to those skilled in the art that various changes or modifications can be made within the spirit and scope of the present disclosure, and accordingly, it is noted that such changes or modifications belong to the appended claims.

Description of Reference Numerals

1: tape dispenser
100: lower case
110: first lower case
120: second lower case
200: upper case
300: blade portion
310: blade handle
320: blade
400: protection cap assembly
410: cover plate
420: locking member
430: first elastic member

What is claimed is:

1. A tape dispenser comprising:
a lower case configured to accommodate a tape therein, and comprising a tape support to which a portion of the tape is adhered;
an upper case connected to the lower case;
a blade portion coupled to the upper case to cut the tape; and
a protection cap assembly provided on a bottom surface of the upper case to cover the blade portion, wherein, when the protection cap assembly is pressed by the support, the protection cap assembly is inserted toward the bottom surface of the upper case to expose at least a portion of the blade portion to an outside.

2. The tape dispenser of claim 1,
wherein the protection cap assembly comprises:
a cover plate configured to cover the blade portion and provided to be inserted into the bottom surface of the upper case;
a locking member disposed between the cover plate and the bottom surface of the upper case to selectively restrict a movement of the cover plate; and
a first elastic member having one side connected to the cover plate and the other side connected to the upper case, and configured to apply an elastic force to the cover plate in an outward direction.

3. The tape dispenser of claim 2,
wherein, when the locking member is spaced apart from the support, the movement of the cover plate is restricted, and
wherein, when the locking member is pressed by the support in contact with the support, the cover plate is inserted toward the bottom surface of the upper case.

4. The tape dispenser of claim 3,
wherein the locking member comprises:
a contact portion provided on the bottom surface of the upper case, and configured to slide inwardly or outwardly when the upper case comes into contact with the support; and
a step portion extended from one side of the contact portion, and configured to restrict the movement of the cover plate in contact with the cover plate, wherein, when the contact portion slides in contact with the support, the step portion is separated from the cover plate.

5. The tape dispenser of claim 4,
wherein the support is provided with a pressing protrusion configured to press against the contact portion in contact with the contact portion.

6. The tape dispenser of claim 4,
wherein the locking member further comprises:
a second elastic member configured to apply an elastic force to the contact portion; and
a guide protrusion provided on the bottom surface of the upper case to guide a movement of the contact portion.

7. The tape dispenser of claim 2,
wherein a first guide slit is formed on the upper case to guide a movement of the blade portion, and
wherein a second guide slit is formed on a position of the cover plate facing the first guide slit.

8. The tape dispenser of claim 7,
wherein a guide groove is formed on a portion of the support facing the second guide slit to prevent interference with the blade portion.

9. The tape dispenser of claim 1,
wherein the upper case is rotatably connected to the lower case at one side, and the other side of the upper case is disposed to face the support when the upper case rotates.

10. The tape dispenser of claim 1,
wherein the blade portion is slidably coupled to the other side of the upper case.

11. The tape dispenser of claim 10,
wherein the blade portion comprises:
a blade handle protruding from a top surface of the upper case; and
a blade connected to the blade handle, and exposed from the bottom surface of the upper case by penetrating through the upper case.

12. The tape dispenser of claim 1,
wherein the blade portion comprises
a blade fixedly coupled to the bottom surface of the upper case, and formed in a saw blade shape having a plurality of cutting concavo-convex portions.

13. The tape dispenser of claim 11,
wherein the blade is a single-edged blade or a double-edged blade.

14. The tape dispenser of claim 11,
wherein the blade is provided in a saw-toothed shape.
